(19) United States
(12) Patent Application Publication
(10) Pub. No.: US 2008/0212847 A1
(43) Pub. Date: Sep. 4, 2008

(54) Method and system for identifying medical sample information source

(76) Inventors: Michael Davies, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 12/007,199

(22) Filed: Jan. 8, 2008

Related U.S. Application Data
(60) Provisional application No. 60/879,032, filed on Jan. 8, 2007.

(51) Int. Cl. G06K 9/00

(52) U.S. Cl. 382/115; 382/190; 382/116; 382/128; 705/3

(57) ABSTRACT

A system and method of providing a unique association of medical data and identity data is taught wherein the medical data and identity data are both extracted from the same biometric information source. Accordingly according to an embodiment of the invention a retinal image provides for both medical data, for example relating to the individuals eye, blood sugar, blood oxygenation etc, and identity data as the retinal image is unique to the individual. As such the invention provides for a secure, reliable, automated association of an individual's identity and their medical data. The unique characteristics of biometric data relating to a single individual relating to the invention allow not only pertinent personal information to be retrieved but also prior medical records as they are now uniquely associated by electronic biometric data, thereby increasing the security associated with their storage and retrieval as they are now locked according to the biometric data and not the simple personal data many people publish online or provide to retailers, financial institutions etc. Such electronic associations allowing medical histories to also become independent of patient, medical institution, etc and confusion, error or oversight.

This application claims the benefit of U.S. Provisional Application No. 60/879,032, filed on Jan. 8, 2007, the entire content of which is incorporated herein by reference.

### FIELD OF THE INVENTION

The invention relates generally to medical testing and more particularly to medical testing sample identification.

### BACKGROUND

Medical testing is a complex and varied field. A typical medical test begins when a patient enters a testing facility, be it a hospital, a doctor's office or a medical test centre. The patient provides their personal information and a file is either retrieved or created in relation to the patient. The file is then used to identify the patient as they pass through the testing process.

For example, if Magnetic Resonance Imaging (MRI) is to be performed, the file is provided to the MRI technician who summons the patient based on the file information. The technician then provides to the MRI system information from the file to identify the patient. The information allows data captured to be stored in association with the patient. Thus, an electronic record is formable based on the entered data and containing the medical test data. Typically the information associating the file with the patient is relatively simple, including for example name, sex, and age which are then associated with a reference number for the hospital's internal tracking and billing systems. Such reference numbers generally being unique to each institution, and in some instance per unique treatment.

As is evident, such a system relies heavily on trust and accuracy of every individual within the chain. An individual to be tested, a technician, a nurse, or a doctor can change the file data and thereby associate medical test data with an incorrect source. This could be a result of error, inadvertence, fraud, mistreatment, serious side effects, and even potentially death. At multiple points within even a simple chain of admitting a patient, assigning them to a doctor, ordering a simple test such as a urine sample, transferring the sample, testing the sample and returning the results to the assigned doctor there exists the potential for these errors to be introduced. It would therefore be advantageous to provide for a means of electronically associating this information with reduced manual intervention and chances of error.

Additionally, in many instances such as an admission into Accident and Emergency (A&E) a battery of tests may be ordered simultaneously, each requiring fast and accurate work by the medical teams under stressful and chaotic conditions. Further in such instances the patient may be unconscious or otherwise incapacitated from speaking and thereby providing the necessary information. It would therefore be beneficial in such cases if the patient was identified by a biometric based characteristic as this would be unique in comparison to J Smith of New York with over 800 matches in the AT&T telephone directory. Advantageously this biometric characteristic if stored within a database accessible by any hospital would allow the identity of the individual within an A&E environment to be determined from their biometric data.

Beneficially the unique characteristics of biometric data relating to a single individual allows that not only can pertinent personal information be retrieved but also prior medical records which are now uniquely associated by electronic biometric data, thereby increasing the security associated with their storage and retrieval as they are now locked according to the biometric data and not the simple personal data many people publish online about themselves without hesitation or provide to retailers, financial institutions etc. Such electronic associations allowing medical histories to also become independent of patient and nurse/doctor error or oversight.

Further it would be advantageous to provide a method of medical testing individuals in any environment that obviates a need for file information provision from an individual to a file, then to a testing system, and then to be applied to a test sample. It would be particularly advantageous if the testing system itself extracted the appropriate biometric data during the testing of the individual to uniquely associate the test results and individual together.

According to the invention there is provided such a beneficial method of associating an individual via biometric data to medical data and allowing said association to be automatically performed as part of a medical test for the individual.

### SUMMARY OF THE INVENTION

In accordance with the invention there is provided a method comprising: sampling a biometric information source to determine biometric data; extracting from the biometric data identity data for use in identifying a source of the biometric information sample; extracting from the biometric data medical data relating to a source of the biometric information sample; and, storing the medical data in association with an index based on the identity data.

In accordance with another aspect of the invention there is provided a system comprising: a transducer for sampling a biometric information source to determine biometric data; and a processor for extracting from the biometric data identity data for use in identifying a source of the biometric information sample, extracting from the biometric data medical data relating to a source of the biometric information sample, and storing the medical data in association with an index based on the identity data.

### BRIEF DESCRIPTION OF DIAGRAMS

The invention will now be described with reference to the attached drawings in which:

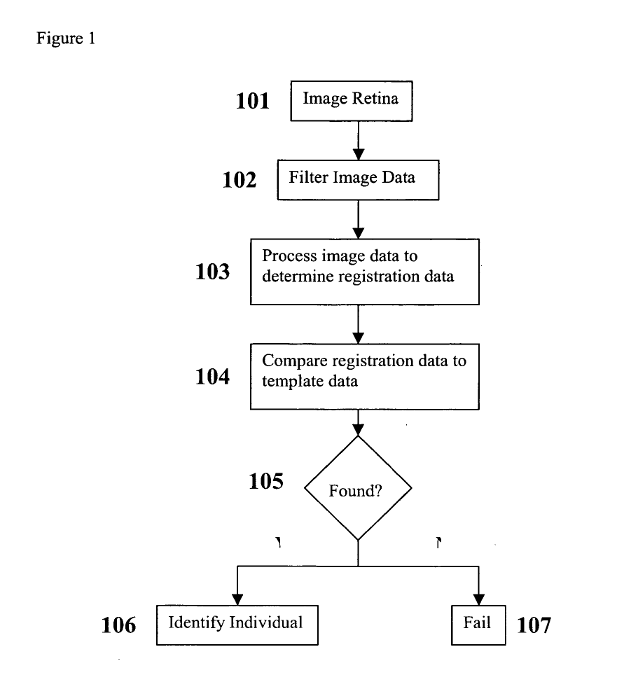

FIG. 1 illustrates a simplified flow diagram of a method of biometric authentication;

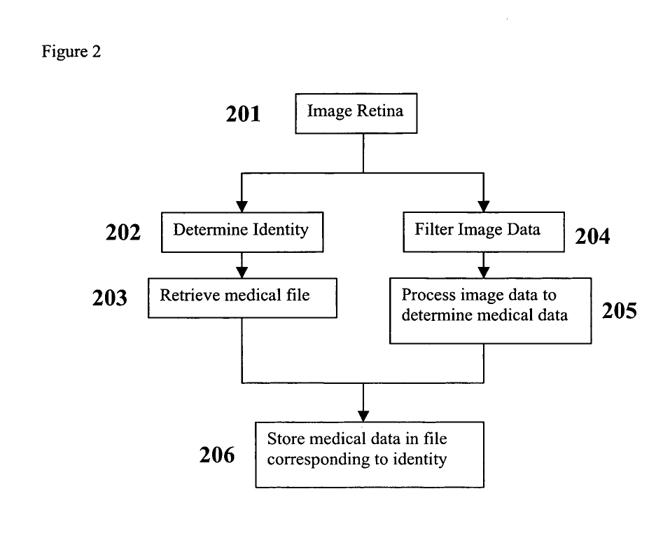

FIG. 2 illustrates a simplified flow diagram of a method of correctly associating medical data with an individual's medical file through biometric authentication and determination of the identity of the individual;

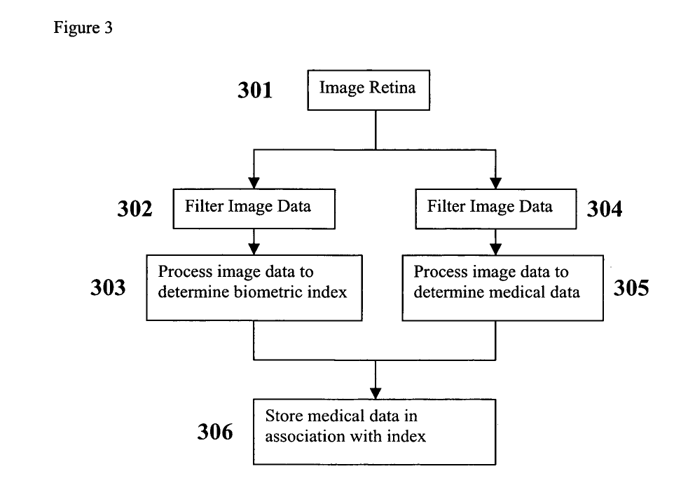

FIG. 3 illustrates a simplified flow diagram of a method of associating medical data with an individual's medical file through biometric indexing absent identifying the individual;

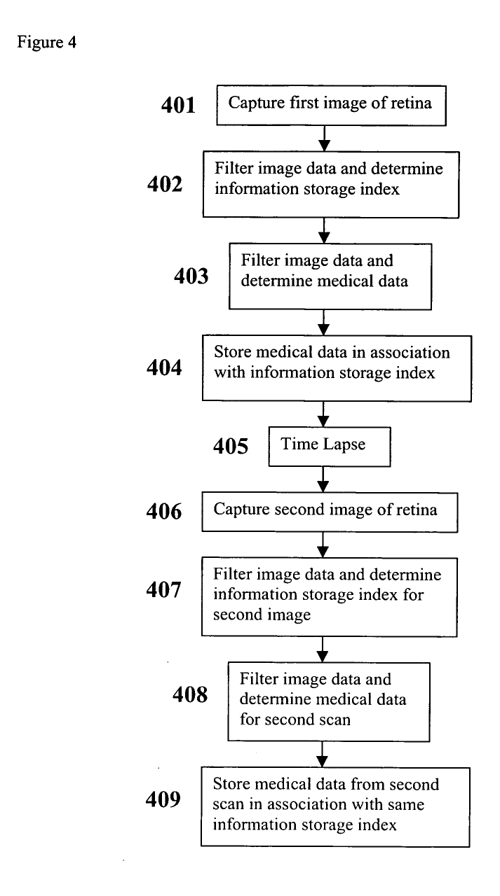

FIG. 4 illustrates a simplified flow diagram of a process of associating medical data captured at different times and of a same patient to a same file;

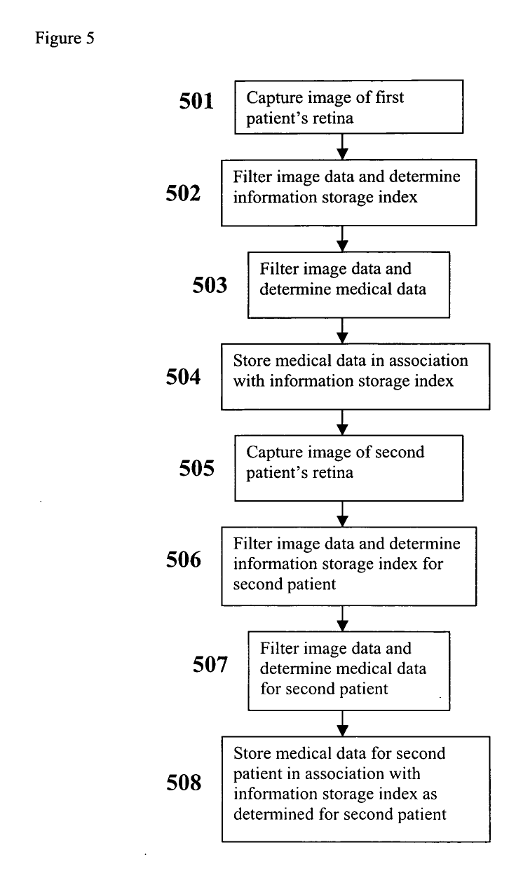

FIG. 5 illustrates a simplified flow diagram of a process of associating medical data captured at different times and of different patient;

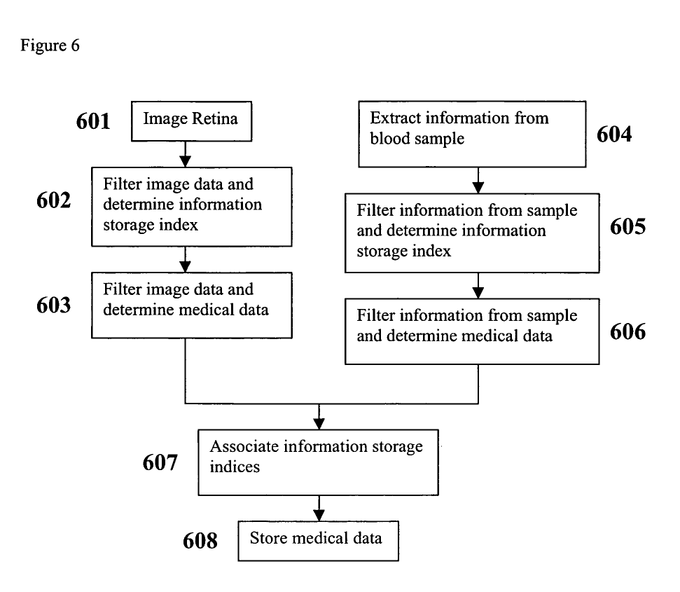

FIG. 6 illustrates a simplified flow diagram of a process of associating medical data captured at different times and having different biometric information therein with a same file;

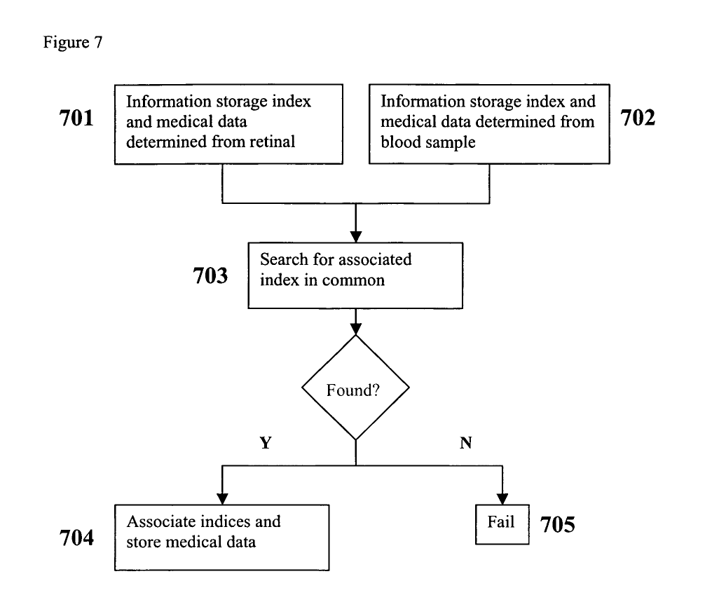

FIG. 7 illustrates a simplified flow diagram of a process of associating medical data captured at different times and having different biometric information;

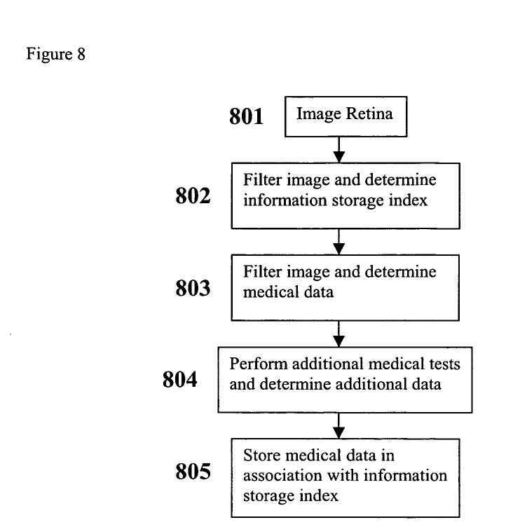

FIG. 8 illustrates a simplified flow diagram of a process for reducing a likelihood for human error in associating the data with the patient; and,

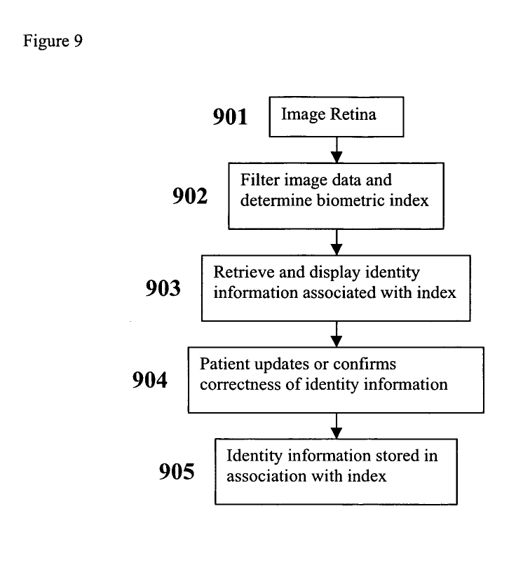

FIG. 9 illustrates a simplified flow diagram of a process for providing a confirmation of a determined index to ensure proper allocation and storage of medical data.

### DETAILED DESCRIPTION OF EMBODIMENTS OF THE INVENTION

The term medical data is used herein and in the claims that follow to refer to health related data for use in healthcare and includes dental data, medical data, diagnostic data, and lifestyle data for use in providing health care. The medical data being derived from any invasive and non-invasive of which non-limiting examples include MRI, computed tomography, biopsy, comprehensive blood panel (CBP), arterial blood gas, blood sugar, electroencephalogram (EEG), and ultrasound.

The term biometric data is used herein and in the claims that follow to refer data derived from a biological source. Non-limiting examples of biometric data include images of biological material or surfaces, X-rays and other scans of living organisms, samples of biological material, diagnostics of biological materials or living matter, and tests relating to living matter or biological materials.

Though the method herein is described with reference to a retinal scan, other forms of biometric authentication are well known to those of skill in the art of biometric identification. A non-exhaustive list of methods of biometric identification includes: fingerprint recognition, facial recognition, iris recognition, retinal recognition, DNA recognition, voice recognition, pore pattern recognition, dental recognition, feature damage recognition, and palm print recognition.

Referring to FIG. 1, shown is a simplified flow diagram of a method of biometric authentication. An image of a biometric information source in the form of a retina is captured at 101. At 102 the image is processed to filter out noise and information that is extraneous to the identification process. At 103, the image is analysed to derive therefrom registration data, the registration data substantially unique to the biometric information source. The registration data is then compared to template data within a database of templates to identify an individual that is uniquely associated with a template corresponding to the registration data within known limits at 104. When a template is found, the person is identified at 106. Otherwise, the person is not identified at 107.

For each form of biometric authentication, different processes are used for filtering, for analysing and for registering. These differences are well understood by one of skill in the art of biometric authentication. For example, in voice recognition applications filtering is often performed in the frequency domain whereas for image-based applications, filtering is often performed to remove unreliable artefacts due to dirt, moisture, and so forth present in the imaging process.

Referring to FIG. 2, shown is a simplified flow diagram of a method of associating medical data with an identity determined through biometric authentication. Though the method is described with reference to a retinal scan, other forms of medical testing and biometric authentication are known and may be applicable.

An image of a biometric information source in the form of a retina is captured at 201. At 202 the identity of the patient is determined using a biometric authentication process, for example as illustrated in FIG. 1. The medical file corresponding to the patient whose identity was determined is retrieved at 203. If the identification process fails a new file is created in association with a template formed from the image data. At 204 the image is filtered to remove noise and any information that is not medically of interest. The filtered image is analyzed to derive therefrom medical data at 205. Finally, at 206, the medical data is stored in the associated medical file—retrieved or newly created—in association with the identity that was determined. Optionally further data is captured to form the template upon determining a failure to establish an existing match within the identification process.

Referring to FIG. 3, shown is a simplified flow diagram of an alternative embodiment of the invention wherein proper association of medical data with an individual is performed without identifying the individual patient. The process of indexing medical data is dependent on an index derived from biometric data. An image of a biometric information source in the form of a retina is captured at 301. At 302 the image is filtered to remove noise and information extraneous to a biometric indexing process. At 303, the filtered image is analyzed to determine a biometric index. At 304 the same captured image is filtered to remove noise and any information that is not medically of interest. The filtered image is analyzed to derive therefrom medical data at 305. At 306, the medical data is stored in association with the biometric index.

Optionally, the raw image data or, alternatively, filtered image data is also stored in association with the biometric index. Thus, provision of same biometric information source allows for retrieval of data stored in association therewith. Further, samples of a same biometric information source are stored in association with a same or substantially similar index. Advantageously, medical test data captured according to the invention is automatically stored in association with identifying data and, as such, is less subject to human error in capture and storage thereof. Of course, a patient need only present their biometric information source in order to retrieve their medical records at a later time. Beneficially the patient never actually divulges any information to another individual in this process as the extraction of the biometric data is performed automatically by the test without any human intervention.

Though the phrase any information that is not medically of interest is used hereinabove, information that is medically of interest but is other than substantially significant to a specific test being performed is considered to be not medically of interest even though for another test or another diagnostic it is of interest. Such information may be automatically stored within a record of the patient even if it does not relate to the specific test being performed as it may be appropriate to another test subsequently or aid a subsequent diagnosis.

Referring to FIG. 4, shown is a simplified flow diagram of another embodiment of the invention. Here is illustrated a process applied to a same patient twice. An image of a biometric information source in the form of a retina is captured at 401. At 402 the image is filtered to remove noise and information extraneous to the process of determining a storage index and a resulting filtered image is analyzed to derive therefrom a storage index. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient. At 403 the captured image is filtered to remove noise and any information that is not medically of interest for the medical process and the resulting filtered image is analyzed to derive therefrom medical data. At 404, the medical data is stored in association with the storage index, as determined. The time lapse at 405 represents a time between evaluations of the patient. The length of the time lapse varies from seconds to as long as several years, as determined by consultations between the patient and a professional. The time lapse, however, is characterised in that the patient does not remain stationary for a single same session including said time lapse. Typically, the patient gets up and leaves the office during the time lapse though, alternatively, the patient moves from one diagnostic instrument to another. Further alternatively, the patient remains in a same diagnostic instrument but is re-diagnosed after a human perceptible and punctuated time lapse. A second image of the biometric information source in the form of a retina is captured at 406.

At 407 the image is filtered to remove noise and information extraneous to the process of determining the storage index and the resulting filtered image is analyzed to derive therefrom a storage index. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient. When an existing patient is scanned for a second time the storage index that is determined corresponds with the storage index determined for the first scan; as such, the data from a first and then from subsequent scans is stored in association with a same index. At 408 the second captured image is filtered to remove noise and any information that is not medically of interest and the resulting second filtered image is analyzed to derive therefrom medical data. At 409, the medical data is stored in association with the storage index, as determined. Optionally, the raw image data or, alternatively, filtered image data is also stored in association with the biometric index. Thus, data from different diagnostic operations on a same biometric information source are stored in association and provision of a same biometric information source allows for retrieval of data stored in association therewith. Further, samples of a same biometric information source are stored in association with a same or substantially similar index. This allows diagnostic results relating to different biometric information sources to be linked as well such that providing any of a plurality of biometric information sources provides access to diagnostic data for the patient.

Advantageously, diagnostic data derived based on medical test data is automatically stored in association with identifying data derived from the medical test data itself and, as such, is less subject to human error in storage thereof.

Referring to FIG. 5, shown is a simplified flow diagram illustrating a process for storing of medical data as applied to two different patients according to an embodiment of the invention. An image of a biometric information source in the form of a retina is captured for the first patient at 501. At 502 the image is filtered to remove noise and information extraneous to the process of determining the storage index and the resulting filtered image is analyzed to derive therefrom a storage index for the first patient. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient. At 503 the captured image is filtered to remove noise and any information that is not medically of interest for a current diagnostic process and the resulting filtered image is analyzed to derive therefrom medical data for the first patient. At 504, the medical data for the first patient is stored in association with the storage index, as determined for the first patient.

At 505, an image of a biometric information source in the form of a retina is captured for the second patient. At 506 the image is filtered to remove noise and information extraneous to the process of determining the storage index and the resulting filtered image is analyzed to derive therefrom a storage index for the second patient. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient. For a different patient, the storage index that is determined does not correspond with the storage index determined for the first patient, each storage index being substantially unique to each patient. At 507 the second captured image is filtered to remove noise and any information that is not medically of interest for a current diagnostic process and the resulting second filtered image is analyzed to derive therefrom medical data for the second patient.

At 508, the medical data for the second patient is stored in association with the storage index, as determined for the second patient. Optionally, the raw image data or, alternatively, filtered image data is also stored in association with the biometric index. Thus, provision of same biometric information source of the first patient allows for retrieval of data stored in association with the first patient's file and provision of same biometric information source of the second patient allows for retrieval of data stored in association with the second patient's file. Advantageously, medical test data is automatically stored in association with identifying data and, as such, is automatically sorted and is less subject to human error in capture and storage thereof.

Referring to FIG. 6, shown is a simplified diagram of a process for applying two diagnostic tests to a patient. A retinal scan and a blood test are used as an illustrative example. An image of a biometric information source in the form of a retina is captured at 601. At 602 the image is filtered to remove noise and information extraneous to the process of determining a storage index and analyzed to derive therefrom the storage index. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient.

At 603 the same captured image is filtered to remove noise and any information that is not medically of interest for a current diagnostic process and analyzed to derive therefrom medical data. Information is extracted from a blood sample provided by the same patient that has undergone the retinal scan at 604. At 605 the information is filtered to remove anything extraneous to the process of determining the storage index and the resulting filtered information is analyzed to derive therefrom a storage index. Optionally, the storage index is indicative of a patient's identity as determined by a process similar to that illustrated in FIG. 1. Alternatively, the storage index is independent of the patient identity but is substantially unique to the patient; for example, the storage index includes a biometric index that, while being substantially unique to the patient, in no way identifies the patient. At 606 the information derived from the blood sample is filtered and analyzed to derive therefrom medical data.

At 607, the indices determined from the retinal image and the blood information are associated with each other. If the indices determined are the identity of the patient then the indices are typically identical. If the indices determined are based on biometric data they are substantially unique to the patient even when they appear uncorrelated. Storing both indices in association with each other is advantageous because it allows medical data associated with only one index to be linked with the medical data associated with the other index. This is desirable from the point of view of the professional that will be called upon to assess the medical data because it provides a clearer picture of the patient's overall condition. Further, once associates, all medical data from those biometric information sources are automatically stored in association with each other. At 608, the medical data is stored in association with the indices. Optionally, the raw data or, alternatively, the filtered data is also stored in association with the indices. Thus, provision of either biometric information source allows for retrieval of data stored in association therewith. Further, samples of a same biometric information source are stored in association with a same or substantially similar index. Advantageously, medical test data captured is automatically stored in association with identifying data and, as such, is less subject to human error in capture and storage thereof.

Referring to FIG. 7, shown is a simplified flow diagram of a method for linking medical data from a single patient that is associated with two different indices. A retinal scan and a blood test are used be way of example. At 701, the information storage index and medical data are determined based on a retinal scan of the patient. At 702, the information storage index and medical data are determined based on a blood sample provided by the patient. At 703, a search is then conducted to determine if the retinal storage index and the blood sample storage index have any associating data. Since indices are stored in association with medical data, it is possible that both the retinal index and the blood sample index are associated with a common file. This provides a vehicle through which the indices are recognized as derived from a same patient. An example of such a common index could be the patient's identity or index. If a common association is found then the retinal index and the blood sample index are recognized as originating from the same patient and are thereafter associated with one another or with a same file, at 704. The retinal medical data and the blood sample medical data are thereby linked. If no association is found then the indices originate from distinct patients, at 705.

It would be advantageous to be able to associate medical data acquired by a second device, not used to gather the biometric information, with an index determined from biometric information in such a way as to reduce the possibility of human error in associating the data with the patient. An MRI is one example of such a second device. Referring to FIG. 8, shown is a simplified flow diagram of a method for doing so. An image of a biometric information source in the form of a retina is captured at 801. At 802 the image is filtered to remove noise and information extraneous to the indexing process and the filtered image is analyzed to determine an information storage index. For example, the information is compared to a plurality of template data in order to find an approximate match, and an index associated with the match is then retrieved as the index. Alternatively, the data is analysed to derive a rotation and translation invariant index therefrom that is substantially redeterminable. At 803 the image is filtered to remove noise and any information that is not medically of interest for a current diagnostic process and analyzed to derive therefrom medical data. Alternatively, filtering is not performed. Alternatively, medical data is not determined from the retinal scan. Further alternatively, data from the retinal scan is stored though diagnostic processes are not performed thereon.

At 804, additional medical test(s) are performed and analyzed to determine additional medical data. The additional medical tests are performed so as to ensure that the test is conducted on the same patient. For example, if the additional medical test is an MRI scan, the retinal scan is conducted after the patient has been placed inside the MRI scanner with the MRI scan to begin immediately after the retinal scan is complete. This allows insufficient time, for example, to substitute another person for the patient. Additional means to accomplish this objective are certainly possible and are within the scope of the present embodiment. Finally, at 805, the retinal medical data as well as the additional medical data are stored in association with the information storage index derived from the retinal image. Optionally, the raw data or, alternatively, filtered data is also stored in association with the index. Thus, provision of same biometric information source allows for retrieval of data stored in association therewith and ensures storage of electronic medical records in association with a same or substantially similar index. Advantageously since the medical data is stored in association with index data derived therefrom, it is typically impossible for the data to be fraudulently reassigned or to be misfiled due to human error. Further, an ability to associate further medical data with the electronic file without further data entry by a system operator is also advantageous in reducing an effect of human error. Further advantageously, historical medical data in the form of biometric information is analyzable to assign same to medical files and, as such, the system is also applicable to legacy information when present.

Referring to FIG. 9, shown is a simplified diagram of a process for providing a confirmation of a determined index to ensure proper allocation and storage of medical data. It would be advantageous to have a secure method of confirming a patient's identity so that the identity information is updated with a level of confidence in its accurate storage and allocation. An image of a biometric information source in the form of a patient's retina is captured at 901. At 902 the image is filtered to remove noise and information extraneous to a biometric indexing process and the filtered image is analyzed to determine a biometric index. At 903, identity information that is associated with said biometric index is retrieved and displayed. For example, this information comprises inter alia, patient name, date of birth, address, telephone number, and other contact information. The information is displayed in such a way that only the patient is able to view it. For example, the terminal is situated in a private room. Alternatively, the information is displayed to the patient in a less private fashion. The patient then confirms the retrieved identity information as correct, at 904. Optionally, the patient updates their information at this point to ensure that the information is maintained in an updated fashion. At 905, the updated identity information is stored in association with the biometric index.

Once confirmed, medical data determined through analysis or medical test information captured is stored in association with the confirmed index. Thus, an individual ensures that their data is stored with their file and is provided with a level of confidence in the data storage and association system. Also, the confirmation process allows for patient confirmation of their identity in case two indices are so similar that the system confuses therebetween and potentially mis-associates data.

Alternatively, the confirmation process involves the medical professional instead of or as well as the patient. Optionally, medical data is stored in a separate database from identity data such that accessing the medical database provides no identity related information and is useful for research and such that each record is associated with a medical file and each medical file is associated with a unique individual identity record within the separate database.

Though the above description relates to retinal scans, the methods are applicable to other biometric information. For example, when measuring a pulse with a fingertip sensor, a fingerprint is imaged. Alternatively, when performing blood testing DNA analysis for identification is performed. Of course, other biometric identification methods also apply.

Advantageously, some of the above embodiments allow for retrieval of patient records absent patient consent, co-operation, or consciousness. It is beneficial that a patient entering an emergency room with an emergency condition is assessable as to electronic medical record content. Further, medical tests, etc. performed on a John Doe are associated with a correct electronic medical file automatically so long as the biometric information resulting from the tests is determinable. At a later time, if desired, the indices determined from the tests are linkable to existing indices for other medical data. Thus, amalgamation of health related data is simplified.

Similarly advantageously, a patient's personal information need not be stored prior to performance of testing. Since the indices used for data storage are determined from the medical data, the data is stored in association with a unique patient, whether or not the patient's identity is known. At a later time, the identifying information is optionally presented and linked to the medical data files relating to said patient.

Numerous other embodiments may be envisaged without departing from the spirit or scope of the invention.

What is claimed is:

1. A method comprising:
a) sampling a first biometric information source to determine first biometric data of a plurality of biometric data;
b) extracting from the first biometric data first identity data for use in identifying a source of the first biometric information sample;
c) extracting from the first biometric data first medical data relating to a source of the biometric information sample; and,
d) storing the first medical data in association with a first index, the first index determined in dependence upon at least the first identity data.

2. A method according to claim 1 wherein,
the first biometric information source comprises at least a retina.

3. A method according to claim 2 wherein,
the extracted first medical data relates to at least one of an opthamalogical condition and a blood condition.

4. A method according to claim 3 wherein,
the opthamalogical condition relates to at least one of a cataract and a condition selected from the group comprising H00 through to H59 of the World Health Organization classification “International Statistical Classification of Diseases and Related Health Problems”.

5. A method according to claim 1 wherein,
the first biometric information source comprises blood.

6. A method according to claim 1 comprising:
e) sampling a second biometric information source to determine second biometric data of the plurality of biometric data, the second biometric information source is associated with a same individual providing the first biometric information source;
f) extracting from the second biometric data second identity data for use in identifying a source of the second biometric information sample;
g) extracting from the second biometric data second medical data relating to a source of the second biometric information sample; and,
h) storing the second medical data in association with a second index based on the second identity data.

7. A method according to claim 6 comprising:
associating the first identity data and the second identity data.

8. A method according to claim 6 comprising:
associating the first index and the second index.

9. A method according to claim 6 wherein,
sampling of the first biometric information and of the second biometric information are performed by a same diagnostic system during a same diagnostic session.

10. A method according to claim 6 wherein,
sampling of the first biometric information and of the second biometric information are performed approximately simultaneously.

11. A method according to claim 1 wherein,
the first biometric information source comprises at least a fingerprint and a predetermined portion of a fingerprint.

12. A method according to claim 1 further comprising:
e) retrieving stored identity data, the stored identity data retrieved in dependence upon the first identity data;
f) displaying information to at least an individual associated with the first biometric information source, the information displayed determined in dependence upon at least the stored identity data;
g) requesting confirmation of an identity of the individual associated with the first biometric data; and,
h) executing an action in response to the confirmation, the action being the step of storing the first medical data when the confirmation is positive.

13. A method according to claim 12 further comprising:
i) determining further stored identity data when the confirmation is other than positive, the further stored identity data relating to another individual;
j) retrieving the further stored identity data in dependence upon the first identity data;
k) displaying information to at least the another individual, the information displayed determined in dependence upon at least the further stored identity data;
l) requesting confirmation of an identity of the another individual associated with the first biometric data; and,
m) executing an action in response to the confirmation, the action being the step of storing the medical data in association with the further stored identity data when the confirmation is positive.

14. A method according to claim 13 further comprising;
n) iterating steps (i) through (m) until a positive confirmation is received.

15. A method according to claim 12 further comprising;
i) creating a new medical file and storing the medical data in association with the new medical file when the confirmation is other than positive.

16. The method according to claim 1 wherein,
the medical data is stored in a database indexed according to plurality of biometric data.

17. A method according to claim 1 wherein,
the first biometric data is collected using at least one of a retinoscope, a direct opthalmoscope, a binocular indirect opthalmoscope, and a monocular indirect opthalmoscope.

18. A method according to claim 1 wherein,
the first biometric data is collected using at least one of fluorescein angiography, indocyanine green angiography, optical coherence tomography (OCT), optical coherence tomographic ophthalmoscopy, scanning laser tomography, scanning laser polarimetry, and adaptive optics ophthalmoscopy.

19. A system comprising:
a) a transducer for sampling a biometric information source to determine first biometric data of a plurality of biometric data; and
b) a processor for extracting from the first biometric data identity data for use in identifying a source of the biometric information sample, extracting from the first biometric data medical data relating to a source of the biometric information sample, and storing the medical data in association with an index, the index determined in dependence upon at least the identity data.

20. A system according to claim 19 wherein,
the transducer comprises at least an optical imager for imaging of at least a portion of an eye.

21. A system according to claim 19 further comprising;
a display for displaying thereon identification data relating to a patient; and,
a second transducer for receiving an input signal, the input signal for one of confirming and denying identification data displayed on the display.
